(19) United States
(12) Patent Application Publication
(10) Pub. No.: US 2024/0430625 A1
(43) Pub. Date: Dec. 26, 2024

(54) HEARING AID COMPRISING AN ACTIVE NOISE CANCELLATION SYSTEM

(71) Applicant: Oticon A/S, Smoerum (DK)

(72) Inventor: Meng GUO, Smoerum (DK)

(21) Appl. No.: 18/339,255

(22) Filed: Jun. 22, 2023

(30) Foreign Application Priority Data
Jun. 24, 2022 (EP) 22180947.8

(51) Int. Cl. H04R 25/00

(52) U.S. Cl. CPC H04R 25/45

(57) ABSTRACT

Disclosed herein are embodiments of a hearing aid configured to be worn at an ear having an active noise cancellation system configured to cancel or reduce directly propagated sound from said environment to said eardrum of the user. The active noise cancellation system can include an adaptive filter configured to provide a feedforward cancellation signal to compensate the directly propagated sound of an acoustic propagation path from said first input transducer to said second input transducer. Methods of operating a hearing aid are further disclosed.

### TECHNICAL FIELD

The present application relates to the field of hearing aids or headsets.

### SUMMARY

When applying active noise cancellation (ANC) in a hearing aid (or headset), the ANC filter can be obtained before use of the hearing aid and remain fixed. However, for optimal noise cancellation performance, an adaptive ANC filter (C) following the changes (over time) of the primary path (P) and the secondary path (S) has to be used.

It can be shown that a standard adaptive ANC filter update (from textbook) in a hearing aid application will be challenging, due to the desired hearing aid output signal acts as a disturbing signal for the adaptive ANC filter estimation.

In present disclosure, a modification to the standard adaptive ANC filter update (from textbook) is proposed.

A hearing aid:

In an aspect of the present application, a hearing aid configured to be worn at an ear, at least partially in an ear canal comprising an eardrum, of a user, the hearing aid is provided.

The hearing aid comprises
a first input transducer for converting first sound in an environment around the hearing aid to a first electric input signal representing said sound in said environment;
a second input transducer for converting sound in said ear canal, e.g. at said eardrum, of the user to a second electric input signal representing said sound in said ear canal, e.g. at said eardrum;
a hearing aid processor for processing said first and second electric input signals, or signals depending thereon, and to provide a processed signal based thereon;
an output transducer for converting said processed signal, or a signal depending thereon, to acoustic stimuli presented to said eardrum of the user;
an active noise cancellation system configured to cancel or reduce directly propagated sound from said environment to said eardrum of the user, said active noise cancellation system comprising an adaptive filter configured to provide a cancellation signal to compensate the directly propagated sound of an acoustic propagation path from said first input transducer to said second input transducer, and a combination unit for combining, e.g. subtracting, said estimate of the directly propagated sound with, e.g. from, said processed signal, the adaptive filter comprising a variable filter and an adaptive algorithm, the adaptive algorithm being configured to provide update filter coefficients to the variable filter in dependence of first and second algorithm input signals.

The first algorithm input signal may comprise said first electric input signal, or a signal dependent thereon, and said second algorithm input signal comprises a combination of said second electric input signal and said processed signal, or a signal or signals depending thereon.

Thereby an improved hearing aid may be provided.

The variable filter (of the ANC system) may be configured to provide the estimate of the directly propagated sound by filtering the first electric input signal, or a signal originating therefrom, with the update filter coefficients provided by the adaptive algorithm.

The variable filter of the ANC system (cf. filter Ĉ of FIG. 2 and FIG. 3) is termed a feedforward ANC filter and its output (cf. y_{c} of FIG. 2 and FIG. 3) is termed a feedforward ANC signal. The term ‘feedforward-ANC’ is used as opposed to ‘feedback ANC’. A feedforward ANC system makes use of the microphone signal facing the environment to create a feedforward cancellation signal, whereas such an environment signal is not necessary (or available) in a feedback ANC configuration. A feedforward ANC-system as well as a feedback ANC system may comprise a microphone (often referred to as the error microphone) facing the eardrum (or any other desired noise cancellation point) and providing a so-called ‘error signal’. The feedback ANC system has to solely generate a noise cancellation signal based on the error microphone signal.

The term ‘compensate the directly propagated sound . . . ’ may in the present context be taken to mean ‘reduce’ or ‘cancel’ the effect of the ‘directly propagated sound . . . .’

The first algorithm input signal may comprise a filtered version of the first electric input signal, which is provided by a filter estimating an acoustic transfer function from said output transducer to said second input transducer, e.g. from an electric input to the output transducer to an electric output of the second input transducer.

The second algorithm input signal comprises a combination of said second electric input signal and a filtered version of said processed signal, wherein said filtered version of said processed signal is provided by a filter estimating a transfer function of a secondary path from an electrical input to the output transducer to an electrical output of the second input transducer. The secondary path transfer function (S) thus includes:
1. The hearing aid output transducer transfer function,
2. The acoustic transfer function from the output transducer to the second input transducer, and
3. The second input transducer transfer function.

The second algorithm input signal comprises a subtraction of a filtered version of the processed signal from said second electric input signal, wherein the filtered version of the processed signal is provided by a filter estimating a transfer function from (an electrical input to) the output transducer to (an electrical output of) the second input transducer.

The hearing aid may comprise a housing configured to be located at least partially in the ear canal of the user. The housing may form part of an earpiece of the hearing aid.

The housing may comprise a ventilation or leakage channel allowing an exchange of air between the environment and a volume at the eardrum occluded by the housing, when the hearing aid is mounted at the ear of the user.

Filter coefficients of the filter estimating the transfer function of the secondary path from the output transducer to the second input transducer, may be fixed, e.g. pre-defined. The filter coefficients may e.g. be determined (e.g. in an acoustic laboratory) in advance of use of the hearing aid by the user, e.g. using a model of the human head and torso (e.g. a HATS or KEMAR model), or based on corresponding measurements on the user, while (the model or the user) wearing the hearing instrument.

Filter coefficients of the filter estimating the acoustic transfer function of the secondary path from the output transducer to the second input transducer, may be adaptive, and updated while the user is wearing the hearing aid.

The adaptive algorithm may comprise a Least Mean Square (LMS) or a Normalized LMS (NLMS) algorithm, or other appropriate adaptive algorithms, e.g. Recursive Least Square (RLS).

The hearing aid may be constituted by or comprise an air-conduction type hearing aid, e.g. a behind the ear (BTE) style, or a receiver in the (RITE) ear style, hearing aid.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The hearing aid may comprise an output unit for providing a stimulus perceived by the user as an acoustic signal based on a processed electric signal. The output unit may comprise a number of electrodes of a cochlear implant (for a CI type hearing aid) or a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a transmitter for transmitting sound picked up—by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The hearing aid may comprise antenna and transceiver circuitry allowing a wireless link to an entertainment device (e.g. a TV-set), a communication device (e.g. a telephone), a wireless microphone, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology), or Ultra WideBand (UWB) technology.

The hearing aid may be or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, e.g. less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time to (or n), each audio sample representing the value of the acoustic signal at to by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥²fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-) frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g. an acceleration sensor. The movement detector may be configured to detect movement of the user's facial muscles and/or bones, e.g. due to speech or chewing (e.g. jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a neural network, e.g. a trained neural network.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path, but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. A hearing system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

Use:

In an aspect, use of a hearing aid as described above, in the ‘detailed description of embodiments’ and in the claims, is moreover provided. Use may be provided in a system comprising one or more hearing aids (e.g. hearing instruments), headsets, ear phones, active ear protection systems, etc., e.g. in handsfree telephone systems, teleconferencing systems (e.g. including a speakerphone), public address systems, karaoke systems, classroom amplification systems, etc.

A method:

In an aspect, a method of operating a hearing aid configured to be worn at an ear, at least partially in an ear canal comprising an eardrum, of a user, is provided by the present disclosure. The method comprises
providing by a first input transducer a first electric input signal representing sound in an environment around the user;
providing by a second input transducer a second electric input signal representing sound in said ear canal, e.g. at said eardrum;
processing said first and second electric input signals, or signals depending thereon, and providing a processed signal based thereon;
converting by an output transducer said processed signal, or a signal depending thereon, to acoustic stimuli presented to said eardrum of the user;
cancelling or reducing directly propagated sound from said environment to said eardrum of the user, by
   adaptively filtering said first electric input signal (y), or a signal originating therefrom, thereby providing a cancellation signal to compensate the directly propagated sound of an acoustic propagation path from said first input transducer to said second input transducer, and
   combining, e.g. subtracting, said estimate of the directly propagated sound with, e.g. from, said processed signal, and
   providing by an adaptive algorithm update filter coefficients in dependence of first and second algorithm input signals,
   providing said cancellation signal by said adaptive filtering using said update filter coefficients.

The method may further comprise
providing that said first algorithm input signal comprises said first electric input signal, or a signal dependent thereon, and that said second algorithm input signal comprises a combination of said second electric input signal and said processed signal, or a signal or signals depending thereon.

It is intended that some or all of the structural features of the device described above, in the ‘detailed description of embodiments’ or in the claims can be combined with embodiments of the method, when appropriately substituted by a corresponding process and vice versa. Embodiments of the method have the same advantages as the corresponding devices.

The first algorithm input signal may comprise a filtered version of the first electric input signal, which is provided by a filter estimating a transfer function of a secondary path from the output transducer to the second input transducer.

The second algorithm input signal may comprise a combination of the second electric input signal and a filtered version of the processed signal, wherein the filtered version of the processed signal is provided by a filter estimating a transfer function of a secondary path from output transducer to the second input transducer.

A computer readable medium or data carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

A computer program:

A computer program (product) comprising instructions which, when the program is executed by a computer, cause the computer to carry out (steps of) the method described above, in the ‘detailed description of embodiments’ and in the claims is furthermore provided by the present application.

A data processing system:

In an aspect, a data processing system comprising a processor and program code means for causing the processor to perform at least some (such as a majority or all) of the steps of the method described above, in the ‘detailed description of embodiments’ and in the claims is furthermore provided by the present application.

A hearing system:

In a further aspect, a hearing system comprising a hearing aid as described above, in the ‘detailed description of embodiments’, and in the claims, AND an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

An APP:

In a further aspect, a non-transitory application, termed an APP, is furthermore provided by the present disclosure. The APP comprises executable instructions configured to be executed on an auxiliary device to implement a user interface for a hearing aid or a hearing system described above in the ‘detailed description of embodiments’, and in the claims. The APP may be configured to run on cellular phone, e.g. a smartphone, or on another portable device allowing communication with said hearing aid or said hearing system.

Embodiments of the disclosure may e.g. be useful in applications such as ear-worn electronic audio processing devices, e.g. hearing ads or headsets.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a top-level overview of an ANC system in a hearing aid,

FIG. 2 shows a block diagram of an ANC system in a hearing aid, and

FIG. 3 shows a block diagram of an ANC system comprising a modification according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts.

However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids or headsets, in particular to active noise cancellation in hearing aids or headsets.

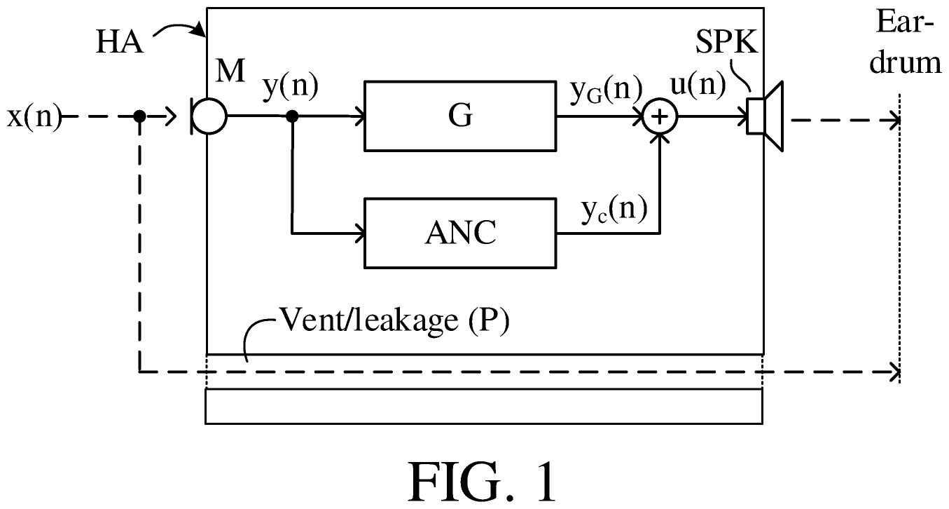

FIG. 1 shows a top-level overview of an ANC system in a hearing aid. The hearing aid (HA) comprises a forward path comprising an input transducer (here a microphone (M)) for converting time-variant sound (x(n), n being time) in the environment to a time-variant electric input signal (y(n)) representing the sound. The forward path further comprises a hearing aid processor (G) for applying a (time) and frequency dependent gain to the electric input signal (y(n)) (or to a signal depending thereon) and to provide a processed signal (y_{G}(n)). The forward path further comprises an output transducer (here a loudspeaker (SPK)) for providing acoustic stimuli to the eardrum of the user in dependence of the processed signal (y_{G}(n)) (or a signal depending thereon (u(n))). The basic idea of the active noise cancellation system is to apply an ANC filter (ANC) to a signal of the forward path, here the electric input signal (y(n)) and to create a cancellation signal to remove the noise sound inside the ear (ideally at the ear drum). The noise sound is the environment sound leaked through a ventilation channel and/or the leakage between the ear canal and an earpiece of the hearing aid, cf. symbolic channel denoted ‘Vent/leakage (P)’ in FIG. 1. In the embodiment of FIG. 1, the ANC-filter (ANC) provides a (feedforward) cancellation signal (y_{c}(n)) in dependence of the electric input signal (y(n)) from the input transducer (M). Instead of the single microphone signal (y(n)) of FIG. 1, the ANC filter may receive a combined signal (e.g. a beamformed signal from a multitude of input transducers), or a signal dependent thereon, e.g. a feedback corrected signal). The cancellation signal (y_{c}(n)) is combined with the processed signal (y_{G}(n)) in a combination unit (here sum unit ‘+’) to provide a compensated output signal (u(n)) for presentation to the eardrum of the user by the loudspeaker (SPK).

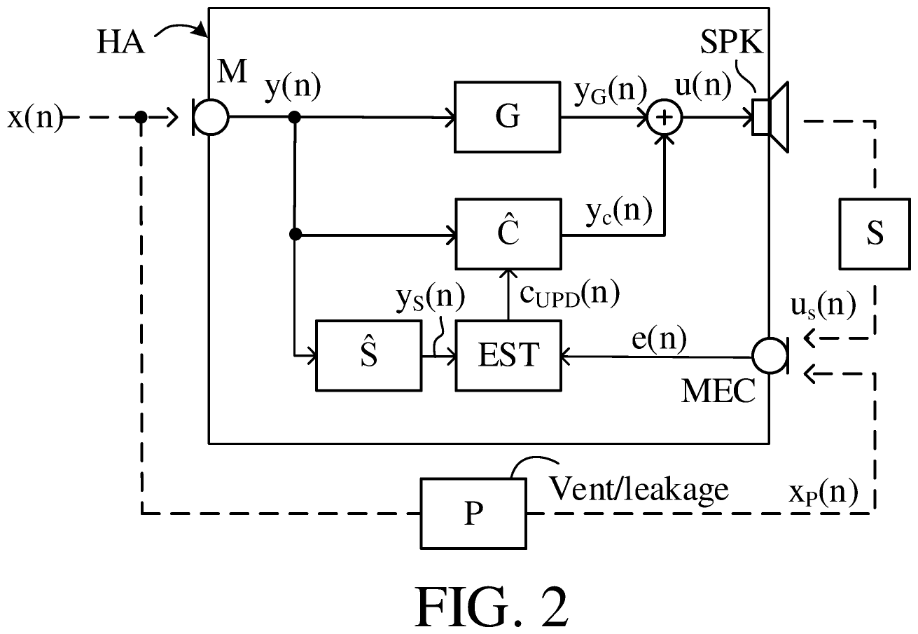

FIG. 2 shows a block diagram of an ANC system in a hearing aid. The goal of the adaptive algorithm (EST), e.g. an LMS (like) algorithm, is to update (cf. signal cUPD(n)) the ANC cancellation filter Ĉ, according to the changes in the primary path transfer function (P) and the secondary path transfer function (S) (cf. signals ys(n) and e(n), respectively). The primary path transfer function (P) (or impulse response) represents a ventilation channel and/or leakage from the environment through/around an earpiece of the hearing aid to the ear canal microphone (MEC) (cf. indication ‘Vent/leakage’ on the block (P) in FIG. 2). Ideally, the ear canal microphone is placed at the eardrum. In practice this microphone is placed close to the eardrum, e.g. in a part of the hearing aid closest to the eardrum when the hearing is worn by the user. The secondary path transfer function (or impulse response) (S) represents an acoustic transfer function from the loudspeaker (SPK) to the ear canal microphone (MEC), including the transfer functions of the loudspeaker (SPK) and the ear canal microphone (MEC). An (feedforward) ANC cancellation signal (y_{c}(n)) created by the (feedforward) ‘cancellation filter’ (ANC, cf. blocks C, EST and S) in dependence of a) the electric input signal (y(n)) from the (environment) microphone (M) and b) the ‘error’ signal picked up by the ear canal microphone (MEC) is added to the desired hearing aid output signal (=processed signal y_{G}(n)), where G denotes the hearing aid processor. The total hearing aid output signal is hence a sum of the desired hearing aid output signal and the cancellation signal: u(n)=y_{G}(n)+y_{c}(n). Ideally, the cancellation signal y_{c}(n) through the secondary path transfer function S models and removes the contribution of the noise signal xₚ(n), as the environment sound x(n) through a ventilation channel and the leakage (at the ‘error microphone’ (or ear canal microphone) MEC). The ‘error signal’ picked up by the ear canal microphone (MEC) can be written as

e(n)=uₛ(n)+xₚ(n)=S*(y_{G}(n)+y_{c}(n))+xₚ(n)=S*y_{c}(n)+S*y_{c}(n)+xₚ(n)=S*y_{G}(n)+e₀(n),
where e₀(n)=S*y_{c}(n)+xₚ(n) represents the desired signal error after the active noise cancellation, and ideally e₀(n)=0.

At the ear canal microphone, the desired hearing aid output signal y_{G}(n) is modified by the secondary path transfer function S and then picked up by the error microphone (MEC), denoted as S*y_{G}(n) in the above expression. The contribution of S*y_{G}(n) is undesired and acts as a disturbance to the adaptive algorithm (EST, e.g. an LMS (like) algorithm) providing the ANC update filter coefficients (cuPD(n)). The term S*y_{G}(n) typically dominates over the term e_{c}(n) in the expression for the error signal (e(n)). In other words, the expectation value E[y_{G}²(n)]>>E[e_{c}²(n)] due to the amplification in the hearing aid processor (G). In practice, this will significantly affect the estimation accuracy and the convergence speed of the ANC filter Ĉ, and in the worst case it is not possible to adapt the ANC filter correctly.

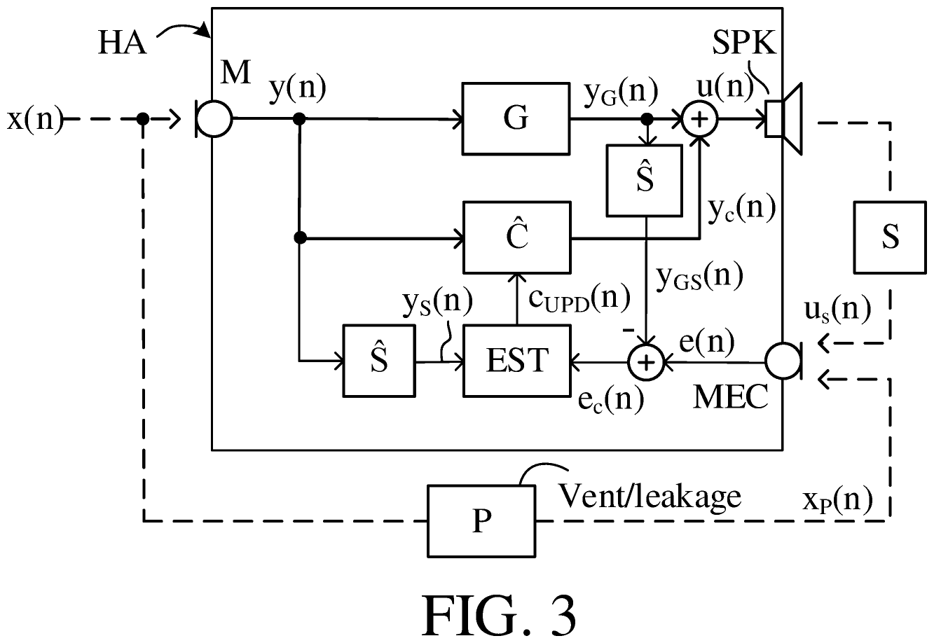

FIG. 3 shows a block diagram of an ANC system comprising a modification according to the present disclosure. FIG. 3. Illustrates a solution to the problem mentioned above in connection with FIG. 2. The embodiment of FIG. 3 is identical to the embodiment of FIG. 2 described above apart from an extra signal path from the output of the hearing aid processor (G), cf. signal (y_{G}(n)), to the output of the ear canal microphone (MEC), cf. error signal e(n). The extra signal path comprises a filter Ŝ and a combination unit (‘+). The extra signal path subtracts (by a combination unit (here a subtraction unit (‘+’, cf. ‘-’ on the y_{GS}(n)-input to the combination unit)) a compensation signal (y_{GS}(n)) from the error microphone signal e(n), and thereby providing a compensated error signal (e_{c}(n)), which is used as input to the adaptive algorithm (EST). The compensation signal (y_{GS}(n)) is a filtered version of the desired hearing aid output signal y_{G}(n), where the filter S is an estimate of the secondary path transfer function S from the loudspeaker (SPK) to the ear canal microphone (MEC).

The ‘error signal’ picked up by the ear canal microphone (MEC) and corrected by y_{GS}(n) can be written as e_{c}(n)=e(n)−y_{GS}(n)=S*y_{G}(n)−Ŝ*y_{G}(n)+e₀(n)˜=e₀(n), assuming that Ŝ ˜=S.

In practical hearing aid applications, the secondary path transfer function depends on the users' ears as well as the hearing aid style. Ideally, an adaptive estimation of the secondary path transfer function S is preferred and then used as S. Alternately, a pre-defined and fixed secondary path estimate Ŝ can be used, and this fixed estimate S can be measured on the user's ear during a hearing aid fitting session, or it can be determined based on measurements in an acoustic lab, e.g. using a model of a human head (e.g. a HATS or KEMAR model).

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid configured to be worn at an ear, at least partially in an ear canal comprising an eardrum, of a user, the hearing aid comprising:
a first input transducer for converting first sound in an environment around the hearing aid to a first electric input signal representing said sound in said environment;
a second input transducer for converting sound in said ear canal of the user to a second electric input signal representing said sound in said ear canal;
a hearing aid processor for processing said first and second electric input signals, or signals depending thereon, and to provide a processed signal based thereon;
an output transducer for converting said processed signal, or a signal depending thereon, to acoustic stimuli presented to said eardrum of the user;
an active noise cancellation system configured to cancel or reduce directly propagated sound from said environment to said eardrum of the user, said active noise cancellation system comprising an adaptive filter configured to provide a feedforward cancellation signal to compensate the directly propagated sound of an acoustic propagation path from said first input transducer to said second input transducer, and a combination unit for combining said estimate of the directly propagated sound with said processed signal, the adaptive filter comprising a variable filter and an adaptive algorithm, the adaptive algorithm being configured to provide update filter coefficients to the variable filter in dependence of first and second algorithm input signals,
wherein said first algorithm input signal comprises said first electric input signal, or a signal dependent thereon, and said second algorithm input signal comprises a combination of said second electric input signal and said processed signal, or a signal or signals depending thereon.

2. A hearing aid according to claim 1 wherein said first algorithm input signal comprises a filtered version of said first electric input signal, which is provided by a filter estimating a transfer function from said output transducer to said second input transducer,

3. A hearing aid according to claim 1 wherein said second algorithm input signal comprises a combination of said second electric input signal and a filtered version of said processed signal, wherein said filtered version of said processed signal is provided by a filter estimating a transfer function of a secondary path from an electrical input to said output transducer to an electrical output of said second input transducer.

4. A hearing aid according to claim 1 wherein said second algorithm input signal comprises a subtraction of a filtered version of said processed signal from said second electric input signal, wherein said filtered version of said processed signal is provided by a filter estimating a transfer function from an electrical input to said output transducer to an electrical output of said second input transducer.

5. A hearing aid according to claim 1 comprising a housing configured to be located at least partially in the ear canal of the user.

6. A hearing aid according to claim 5 wherein the housing comprises a ventilation or leakage channel allowing an exchange of air between the environment and a volume at the eardrum occluded by the housing, when the hearing aid is mounted at the ear of the user.

7. A hearing aid according to claim 1 wherein filter coefficients of the filter estimating the transfer function from said output transducer to said second input transducer are fixed.

8. A hearing aid according to claim 1 wherein filter coefficients of the filter estimating the transfer function from said output transducer to said second input transducer are pre-defined.

9. A hearing aid according to claim 1 wherein filter coefficients of the filter estimating the transfer function from said output transducer to said second input transducer, are adaptive, and updated while the user is wearing the hearing aid.

10. A hearing aid according to claim 1 wherein said adaptive algorithm is an LMS or an NLMS algorithm.

11. A hearing aid according to claim 1 wherein the variable filter is configured to provide the estimate of the directly propagated sound by filtering the first electric input signal, or a signal originating therefrom, with the update filter coefficients provided by the adaptive algorithm.

12. A hearing aid according to claim 1 being constituted by or comprising an air-conduction type hearing aid.

13. A method of operating a hearing aid configured to be worn at an ear, at least partially in an ear canal comprising an eardrum, of a user, the method comprising:
providing by a first input transducer a first electric input signal representing sound in an environment around the user;
providing by a second input transducer a second electric input signal representing sound in said ear canal;
processing said first and second electric input signals, or signals depending thereon, and providing a processed signal based thereon;
converting by an output transducer said processed signal, or a signal depending thereon, to acoustic stimuli presented to said eardrum of the user;
cancelling or reducing directly propagated sound from said environment to said eardrum of the user, by:
adaptively filtering said first electric input signal, or a signal originating therefrom, thereby providing a feedforward cancellation signal to compensate the directly propagated sound of an acoustic propagation path from said first input transducer to said second input transducer, and
combining said estimate of the directly propagated sound with said processed signal, and
providing by an adaptive algorithm update filter coefficients in dependence of first and second algorithm input signals,
providing said feedforward cancellation signal by said adaptive filtering using said update filter coefficients,
wherein said first algorithm input signal comprises said first electric input signal, or a signal dependent thereon, and said second algorithm input signal comprises a combination of said second electric input signal and said processed signal, or a signal or signals depending thereon.

14. A method according to claim 13 wherein said first algorithm input signal comprises a filtered version of said first electric input signal, which is provided by a filter estimating a transfer function of a secondary path from said output transducer to said second input transducer.

15. A method according to claim 13 wherein said second algorithm input signal comprises a combination of said second electric input signal and a filtered version of said processed signal, wherein said filtered version of said processed signal is provided by a filter estimating a transfer function of a secondary path from said output transducer to said second input transducer.

16. A computer program comprising instructions which, when the program is executed by a computer, cause the computer to carry out the method of claim 12.
